(19) United States
(12) Patent Application Publication
(10) Pub. No.: US 2023/0019856 A1
(43) Pub. Date: Jan. 19, 2023

(54) ARTIFICIAL INTELLIGENCE MACHINE LEARNING PLATFORM TRAINED TO PREDICT DISPATCH OUTCOME

(71) Applicant: TrueBlue, Inc., Tacoma, WA (US)

(72) Inventors: Carlos Lara Maldonado, Dallas, TX (US); Robert Michael Ward, Issaquah, WA (US); Jeffrey S. Dirks, Kirkland, WA (US); Christopher A. Kapcar, Hinsdale, IL (US)

(21) Appl. No.: 17/379,708

(22) Filed: Jul. 19, 2021

(51) Int. Cl. G06Q 10/06; G06Q 10/10; G06N 20/00

(52) U.S. Cl. CPC G06Q 10/063112; G06Q 10/1053; G06N 20/00

(57) ABSTRACT

Disclosed is a platform that manages worker users in a temporary staffing environment via an AI machine learning model. The machine learning model predicts dispatch outcomes of a plurality of pairings of worker users to potential shifts. A dispatch outcome predicts whether a worker will show up for and work a given shift. The machine learning model is based on a set of training data surrounding historical dispatch outcomes. The data surrounding the historical dispatch outcomes includes data relating to users, data relating to shifts, and data derived from a combination of both. An implementation of the machine learning model stitches together multiple shifts for up to a schedule horizon based on predicted dispatch outcomes.

### TECHNICAL FIELD

The disclosure relates to the training and implementation of artificial intelligence (AI) machine learning models. More particularly, the disclosure relates to predicting an outcome of a given dispatch for a temporary staffing position via machine learning model.

### BACKGROUND

Traditionally, temporary employment staffing systems have included branch offices where potential workers arrive early in the morning and are directed to various available temporary staffing positions for the day (e.g., event and convention workers, construction, skilled laborers, one-time projects, etc.). A given employer requests a number of workers for a task and a staffing organization fills those requests with available temporary associates.

Human assignment of temporary workers is complicated by instances of dispatched/paired associates not showing up to their assigned tasks or shifts. The human response to no-shows is to overbook arbitrarily or use judgment based on personal connections and trust relationships between dispatcher and associate. The human response is inefficient, often inaccurate, and suffers from relationship loss due to turnover.

### BRIEF DESCRIPTION OF THE DRAWINGS

FIG. 1 is an example of a particular embodiment of the present invention that can be realized using a processing device.

FIG. 2 illustrates a networked communications system that may include the processing device.

FIG. 3 illustrates a system diagram of a system for matching workers to entities which define jobs, according to embodiments of the present disclosure.

FIG. 4 is a flowchart illustrating a machine learning model flow for a predictive work rate model, according to embodiments of the present disclosure.

FIG. 5 is a block diagram of a schedule stitching platform, according to embodiments of the present disclosure.

FIG. 6 is a flowchart illustrating a schedule stitching using a predictive work rate match, according to embodiments of the present disclosure.

### DETAILED DESCRIPTION

Short-term, temporary employment staffing platforms operate by linking a number of available workers to gigs (e.g., short-term, temporary employment). Available jobs are matched to workers and recommended thereto. In the examples described below, the matching process is based on a machine learning model that is trained to answer a primary question, e.g., given a particular dispatch pairing (associate-to-task), will the outcome result in a worked/paid shift? The machine learning model may be implemented as any of a hidden Markov model (HNM), neural networks (NN), convolutional neural networks (CNN), or known equivalents.

The primary question answered is different than other matching models in at least, that past models seek to identify fit or aptitude of a given associate for a given task. Other examples identify whether the associate will want to take a given task. Here, the ultimate concern is different. Specifically, the model disclosed herein predicts whether the associate will work the shift (e.g., show up to the shift and work that shift). A negative prediction is that the associate will not work the shift for any reason (e.g., decline the shift, no-show, etc.).

The machine learning model bases the answer to the primary question on numerous input streams. In some embodiments, the input streams fall into three categories: input relating to the associate, task inputs relating to the shift, and input derived from comparing the associate and task inputs against one another. Note that the below input streams are merely examples and that any suitable input stream or combination of input streams including various factors that influence whether an associate will show up to and complete a shift are contemplated.

Example Input Streams Relating to the Associate Include:

(a) CumulativeWorkerDispatches: At matching time, how many total dispatches has the associate had? (b) CumulativeWorkerProperDispatches: At matching time, how many total paid shifts has the associate had? (c) WorkerReliabilityScoreAtDispatch: At matching time, what is the associate's ratio of total paid shifts to total dispatches (e.g., (b) to (a))? (d) DaysSinceFirstDispatchAtDispatch: At matching time, how many days has it been since the associate's first dispatch? (e) AverageDispatchesPerDayAtDispatch: At matching time, what is the associate's average number of dispatches per day since their first dispatch? (f) WorkerSkills: Associate's skills at matching time. (g) CumulativeAverageShiftPayRateAtDispatch: At matching time, what is the associate's average pay rate per paid shift, across all paid shifts? (h) LastShiftPayRateAtDispatch: At matching time, what is the associate's last shift's pay rate? (i) LastShiftLengthAtDispatch: At matching time, what is the associate's last shift's length? (j) CumulativeAverageShiftLengthAtDispatch: At matching time, what is the associate's average number of hours per paid shift, across all paid shifts? (k) LastFullShiftBoolean: At matching time, is the associate's last paid shift for 8+hours? (l) AverageFullShiftRate: At matching time, what is the associate's number of 8+ hour shifts? (m) FullShiftReliabilityScore: At matching time, what is the associate's ratio of 8+ hour shifts to less than 8-hour shifts? (n) CumulativeShiftHoursWorkedAtDispatch: At matching time, how many total hours has the associate been paid for? (o) NextAssignment: if the associate is matched with a given shift at matching time, what effect does that assignment have on the likelihood that the associate's next dispatch is successful?

Example Input Streams Relating to the Task Include:

(a) Identity: the employer's name/title. (b) JobOrderPayRate: At matching time, what is the shift's hourly pay rate? (c) Shift Day & Month: At matching time, what is the shift's date? (d) location: the physical location of the shift (e) JobSkills: The job's requested skills at matching time. (f) JobDuties: The job's work duties at matching time. (g) Industry: The job's industry category at matching time. (h) JobTitle: the title given to the task. (i) JobLength: a length of time a worker is requested for.

Example Input Streams Derived from a Combination of the Task Input and the Associate Input Include:

(a) CumulativeWorkerDispatchesForCustomer: At matching time, how many total dispatches has the associate had for the specific customer? (b) LastPayRateMatch: At matching time, does the associate's last paid shift's pay rate match the new job's pay rate? (c) CumulativeWorkerProperDispatchesForCustomer: At matching time, how many total paid shifts has the associate had for the specific customer? (d) WorkerCustomerReliabilityScoreAtDispatch: At matching time, what is the associate's ratio of total paid shifts to total dispatches for the specific customer? (e) JobSkillMatch: At matching time, do any of the associate's skills match any of the job's skills? (f) Distance: At matching time, what is the associate's home distance from the job site?(g) CountofCommonJobTitleAtDispatch: At matching time, how many times has the associate worked a shift with the same job title? (h) LastShiftForCustomer: a Boolean indicating whether the associate's last shift was with the specific customer.

Input streams are weighted relative to one another during model training. The weighting may be performed via training supervision or as unsupervised variants of machine learning models. The weighting is based on whether the model (or a model supervisor) identifies any particular input stream as more significant than another. For example, the input stream for combined data, element H, is a Boolean. In some embodiments, that Boolean is identified as more indicative of a particular result than another input stream. Thus, in those embodiments, the Boolean is weighted more heavily by the model than the other input stream(s). In an example embodiment, a machine learning model was trained with a dataset composed of 3,447,120 records; further split into training/validation/test sets (70/20/10). Dates range from 01/01/2018-12/31/2020.

The records are historical dispatch outcomes including values for numerous input streams. During training, the model is tuned for precision as an objective metric that minimizes false positives (instances where the model recommends a job to which the associate won't show up). The improvements enable the platform to reduce the probability of overbooking due to, e.g., human assignment.

When new data is added to, the training set, the model is modified (e.g., the weights are adjusted) to include the new data. In some embodiments, the machine learning model is trained specifically on data records pertaining to local geographies (e.g., the records originating from Florida are used to train a Florida model, whereas records originating from Washington train the Washington model).

An example of a gig staffing platform makes use of a mobile device application where workers can browse their matches and sign up to work. Once the worker has chosen a job or gig and signs up, the worker shows up and works the gig. Because the positions are temporary (e.g., many lasting no more than a single shift), there does not tend to be any sort of extended evaluation or interview process. If a worker is qualified to sign up for the work, they may sign up and show up to the job. If the worker had worked for a given employer before, there may be a pre-existing evaluation on that worker (e.g., blacklisting or whitelisting the worker).

In many cases, the available jobs have requirements. The requirements vary from certifications, worker skills, worker previous experience, worker ratings, or other known suitable forms of temporary worker evaluations. If a worker does not fit the requirements, they will not be matched, and those jobs will not be available for that associate to take. In some embodiments, the disclosed machine learning model integrates with a mobile application whereby dispatch pairings are communicated to associates.

### Exemplary System Embodiment

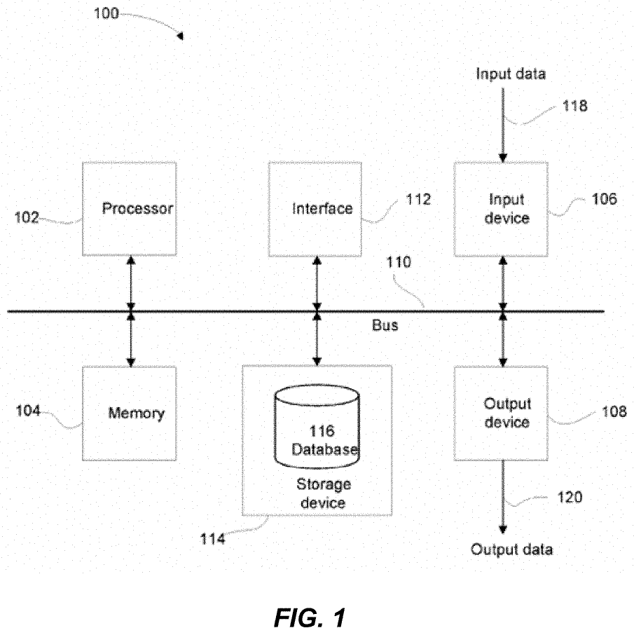

FIG. 1 is an example of a particular embodiment of the present invention can be realized using a processing device. In particular, the processing device 100 generally includes at least one processor 102, or processing unit or plurality of processors, memory 104, at least one input device 106, and at least one output device 108, coupled together via a bus or group of buses 110. In embodiments, processor 102 is coupled to an AI accelerator, e.g., AI integrated circuit chip, which may assist in performing machine learning training and inference in connection with the embodiments described below. For example, such AI integrated circuit chips typically include graphics processing units (GPUs), but may also include tensor processing units (TPUs), field programable gate arrays (FPGAs), or any other customized hardware or suitable AI accelerator. In certain embodiments, input device 106 and output device 108 could be the same device. An interface 112 can also be provided for coupling the processing device 100 to one or more peripheral devices, for example interface 112 could be a PCI card or PC card.

At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing device 100.

In alternative embodiments, the processing device 100 operates as a standalone device or may be connected (networked) to other machines. In a networked deployment, the machine may operate in the capacity of a server or a client machine in a client-server network environment, or as a peer machine in a peer-to-peer (or distributed) network environment.

Input device 106 receives input data 118 (such as electronic content data), for example via a network or from a local storage device. Output device 108 produces or generates output data 120 (such as viewable content) and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

Examples of electronic data storage devices 114 can include disk storage, optical discs, such as CD, DVD, Blu-ray Disc, flash memory/memory card (e.g., solid state semiconductor memory), Multimedia Card, USB sticks or keys, flash drives, Secure Digital (SD) cards, microSD cards, miniSD cards, SDHC cards, miniSDSC cards, solid state drives, and the like.

In use, the processing device 100 is adapted to allow data or information to be stored in and/or retrieved from, via wired or wireless communication means, the at least one database 116. The interface 112 may allow wired and/or wireless communication between the processing unit 102 and peripheral components that may serve a specialized purpose. The processor 102 receives instructions as input data 118 via input device 106 and can display processed results or other output to a user by utilizing output device 108. More than one input device 106 and/or output device 108 can be provided. It should be appreciated that the processing device 100 may be any form of terminal, PC, laptop, notebook, tablet, smart phone, specialized hardware, or the like.

The machine may be a server computer, a client computer, a personal computer (PC), a tablet PC, a set-top box (STB), a personal digital assistant (PDA), a cellular telephone or smart phone, a tablet computer, a personal computer, a web appliance, a network router, switch, or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “machine-readable medium” or “machine-readable storage medium” shall also be taken to include any medium that is capable of storing, encoding, or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Discs, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

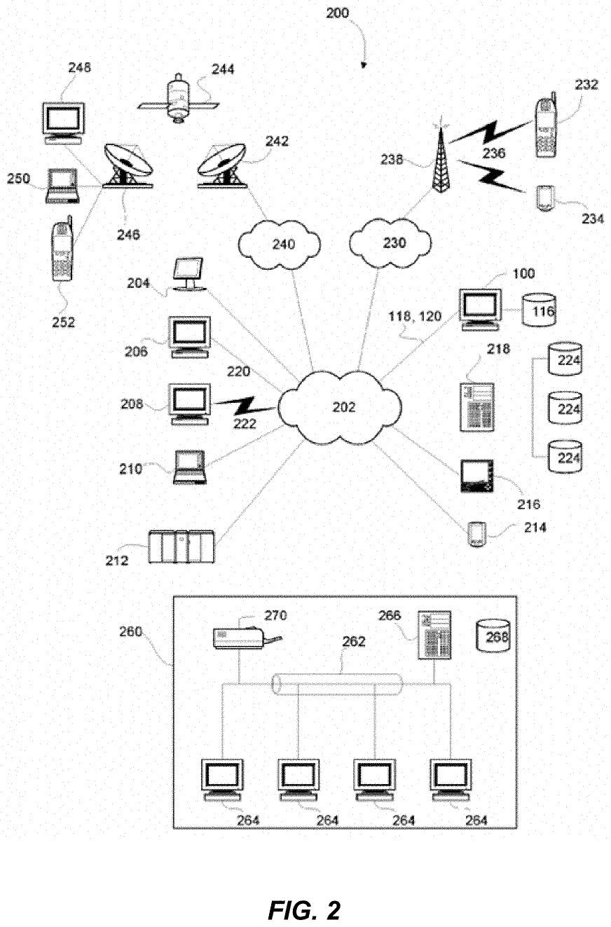

FIG. 2 illustrates a networked communications system 200 that may include the processing device 100. Processing device 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilized. The transfer of information and/or data over network 202 can be achieved using, wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilizing wireless communication means 236 and receiving/transmitting station 238. Mobile telephone 232 devices may load software (client) that communicates with a backend server 206, 212, 218 that operates a backend version of the software. The software client may also execute on other devices 204, 206, 208, and 210. Client users may come in multiple user classes such as worker users and/or employer users.

Satellite communications network 240 could communicate with satellite signal receiver 242 which receives data signals from satellite 244 which in turn is in remote communication with satellite signal transmitter 246. Terminals, for example further processing system 248, notebook computer 250, or satellite telephone 252, can thereby communicate with network 202. A local network 260, which for example may be a private network, LAN, etc., may also be connected to network 202. For example, network 202 may relate to ethernet 262 which connects terminals 264, server 266 which controls the transfer of data to and/or from database 268, and printer 270. Various other types of networks could be utilized.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA, 3G, 4G, etc., networks, and may be wholly or partially wired, including for example optical fiber, or wireless networks, depending on a particular implementation.

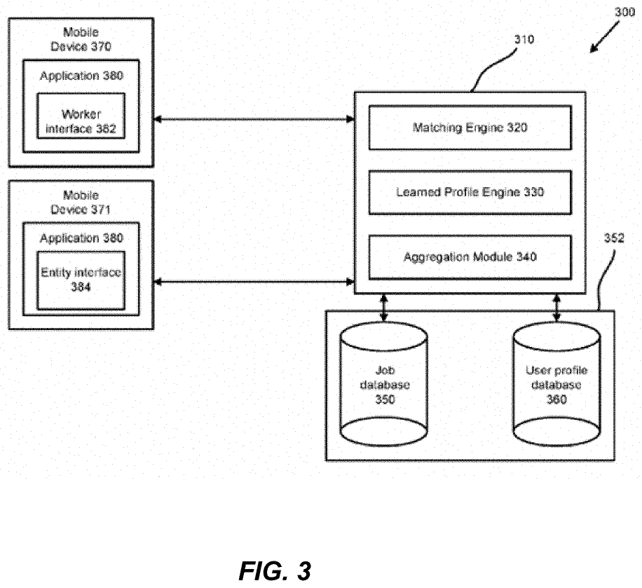

FIG. 3 illustrates a system diagram of a system 300 for pairing associates to tasks. In particular, the system 300 includes a server processing system 310 in data communication with a first and second mobile device 370, 371, preferably smart phones, or tablet processing systems, etc., via a one or more communication networks (e.g., as shown and described in connection with FIG. 2) The first mobile device 370 is operated by an associate and the second mobile device 371 is operated by a task issuer. The system 310 can include a plurality of first and second mobile devices 370, 371 operated by a respective plurality of associates and task issuers. The server processing system 310 may access or include a data store 352 including a user profile database 360 and a job database 350.

The user profile database 360 and job database 350 are configured to be hosted by the server processing system 310; however, it is equally possible that the user profile database 360 and the task database 350 are hosted by other database serving processing systems. The user profile database 360 stores the set of associate data/records used to train machine learning models such as the predictive work rate model 330. The task database 360 stores the set of task data/records used to train machine learning models such as the predictive work rate model 330. Processing system 100 is suitable for operation as the server processing system 310. Embodiments of the server processing system 310 include a matching engine 320, and a predictive work rate model 330 which will be discussed in more detail in various examples below.

In some aspects, the user profile database 360 includes profiles for both workers (associates) and employers (clients). In embodiments, when an employer user has a service request (may be referred to as any of “task,” “job,” “shift,” or “gig”) the employer user makes use of the platform to select a job template that most closely matches the service request that they have and provides the requisite time period the service request is associated with Worker users who match the service request may sign up for the shift and work that service request.

The mobile devices 370, 371, which may be similar to the cellular devices as shown and described in FIG. 2, include a processor, a memory, an input and output device preferably provided in the form of a touch screen interface, and a communication device. Preferably, the mobile device 370, 371 includes a location receiver (such as a Global Positioning System location receiver) 375. The mobile devices 370, 371 have stored in the memory a mobile device application 380 which can be downloaded by the mobile devices 370, 371 from a software repository processing system. The user can register with the server processing system 310 as a worker or an entity of the task issuer. If the user registers as an associate, an associate interface 382 will be presented via the mobile application 380 via their respective mobile device 370. If the user registers as an entity, an entity interface 384 will be presented via the mobile application 380 via their respective mobile device 371. However, it will be appreciated that two separate mobile applications could be provided for the two different types of users in alternate arrangements.

Predictive Work Rate Model

Prior matching models in the temporary staffing sector seek prediction of the wrong outcome. Specifically, those models attempt to identify, given a set of tasks/shifts, which shift will the worker/associate want to agree to. A predictive work rate model instead predicts whether given a pairing of associate and shift, whether the associate will show up and work the shift.

Performing matches based on a predictive work rate model rather than associate preference enables shifting a user interface from a first come-first served model to a direct allocation model. While a predictive work rate model also supports a first-come-first served assignment model, predictive work rate also enables direct allocation. An associate preference model does not enable direct allocation. Typically, an associate preference cannot fundamentally enable direct allocation because it may be difficult to sort collisions (e.g., where two associates would both have the highest preference for a given shift). Associate preference does not treat the shifts like the resource that they are. A given platform does not have unlimited available shifts, thus allocation of shifts to the associates that are most likely to show up and work the shift is more efficient.

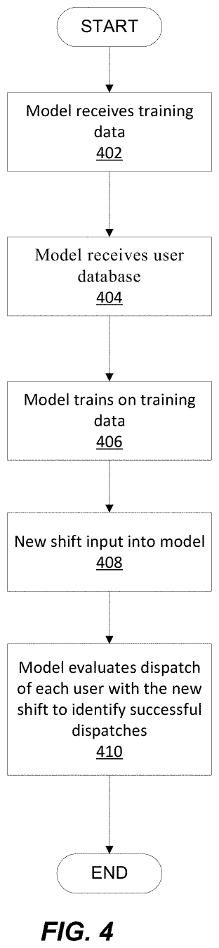

FIG. 4 is a flowchart illustrating a machine learning model flow for a predictive work rate model. In step 402, a model receives a plurality of training data. In some embodiments, the training data includes historical outcomes of dispatches of associates to shifts. The dispatch outcomes may include details of a given shift. For example, the outcomes may include details about the dispatch, such as, but not limited to, what employer requested the shift, duties and requirements of the shift, when and where the shift was, how much the shift paid, etc.), the associate dispatched to that shift, whether the associate arrived to work, whether the associate was on time, and/or feedback from either or both of the associate and the employer.

In step 404, the model receives a user database. The user database is built over the course of multiple dispatch outcomes and self-reporting. Users include both clients/employers and associates/workers. The user database includes raw compiled statistics on each user as well as data relevant to each class of user (e.g., associate/employer). The data relevant to each user may include past requirements for shifts from employers and certifications and skills from associates. The model uses the user database to contextualize the dispatch outcome training data, and further uses the user database to contextualize new input. Note that training data is focused on historical outcomes of selected dispatches and the user database focuses on, for example, individual characteristics and history of workers and employers.

In step 406, the model trains on the training data in order to predict outcomes of potential dispatch pairings. Examples of training data include input streams similar to those described above, e.g., input relating to the associate, task inputs relating to the shift, and/or inputs derived from comparing the associate and task inputs against one another. As new data is collected (e.g., from newly completed dispatches) the training data is updated, as well as the user database. The updates to the user database inform attributes related to the last shift for a given associate. The outcome the model trains on is evaluating whether a given dispatch will be successful.

Notably, whether the dispatch is successful is distinct from whether the users will prefer the shift they are paired with over other shifts. The evaluation is focused on instead whether if the shift was allocated to that user, would the user show up and work the shift to completion, and would the employer be satisfied enough with the job to pay out for the work done. Ultimately, all of the collection of conditions requisite to a successful match are not individually evaluated. Rather, the training data, historical records, are marked as either successful or not. The model then attempts to approximate the conditions of those records marked as successful. Thus, the model is not specifically evaluating whether or not an employer will be satisfied with the work (as a human might), but rather, does a given match have objective attributes that are indicative of a successful dispatch?

In step 408, a new shift is received by the trained model. In step 410, the model evaluates a potential dispatch of the new shift as paired with each associate in the user database. The potential dispatch outputs a confidence score whether the potential pairing will result in a successful dispatch (e.g., the shift will be worked and paid out).

In some embodiments, the confidence score is a percentage, whereas other embodiments output a Boolean as the confidence score. Some embodiments use a combination of the percentage and the Boolean by converting the percentage to a Boolean based on satisfaction of a predetermined threshold.

The output of the model may be used in multiple implementations. Examples include direct allocation schemes where associates are assigned shifts or offered shifts to accept based on the predicted dispatch outcome of the potential dispatches. In some embodiments, associates are allocated to shifts in a manner that improves the (statistical) reliability of that associate in the future (e.g., allocating a given associate for a shift that once added to their statistics improves the prediction of the effectiveness of future allocations). In some embodiments, associates are allocated not based on a best individual match, but rather a greatest number of matches (across all associates on the platform, or within a given geography or temporal period) that meet a predetermined predictive threshold.

Other examples include offering a set of competing shifts (e.g., scheduled at the same time) to a given associate whom scored above a threshold on the predicted dispatch outcome and allow the associate to select their preference.

Schedule Stitching

Typical users of temporary staffing platforms prefer consistency. Associate users are more likely to stick with the platform when those users can obtain consistent employment mimicking full-time employment. It further improves stickiness of a given associate when the shifts they are assigned/take are similar to the recent shifts they have taken. Examples of similarity may include the same time, same place, same employer, same responsibilities, etc. In embodiments, once a given associate has completed a certain threshold, such as but not limited to, e.g., ˜ten to twenty or more consecutive shifts, they have established themselves as a sticky user of the platform that is less likely to churn (cease use of the platform).

Accordingly, providing the associates some analog to full-time employment is a goal. However, it is the inherent nature of a temporary staffing platform that the staffing needs are temporary. The length and notice for positions/tasks are finite. In some cases, it's possible to have a string of shifts that persist for a few months or a season (e.g., seasonal retail assistance), but the more typical case are one-off shifts with one- to seven-day notice.

In this manner, consistent shifts are a resource for the platform to allocate, and the platform can do so via the predictive work rate matching model as described herein. The model identifies, via machine learning, the likelihood that the shift will be worked and paid out. In some embodiments, the model further predicts the outcome on future shifts and that evaluation is recycled back into the model to influence a current output.

For example, the predictive work rate model assumes that it matches the current associate to a current shift. Then, based on that potential dispatch, it can subsequently attempt to match that same associate to a subsequent shift. The model further attempts to match the associate with the subsequent shift where the assumption that the associate was dispatched to the current shift was not made. The two outputs of the model regarding the subsequent shift are compared against each other for differences and the difference indicates the value of the current shift on the propensity for a subsequent shift to be successful. Where associates are new and little user data is available to the system, use of potential dispatch calculations enable the system to generate more data on that user. Using potential dispatches, two current shifts may be adequately compared against one another based on their respective effect on success of subsequent shifts for that associate.

As an example of the above, a given associate is to be matched with a first shift, ex: a construction job. The model seeks to identify the value of this construction job to the predictive statistics of the model. In order to do so, the model first assumes the associate was matched with the construction job, and then attempts to match the associate to a second job, ex: a waste removal job. Using the assumption that the match to the construction job occurred in the associate's work history the associates subsequent match value to the waste removal job will have a first predicted work rate. Then, the model performs the same evaluation of the match to the waste disposal job where the construction job was not part of the associates work history outing a second predicted work rate. Through a comparison of the first and second predicted work rate, the value of the model is enabled to evaluate the value of the construction job on the associate's ability to make future matches.

While availability of reliable or long-term shifts are limited/finite in the platform, a series of shorter shifts may be stitched together by the platform using the predictive work rate model. For example, a set of 5 or 7 unrelated 1-day shifts are preemptively assigned a given associate for a week's worth of work based on the predictive work rate model. As the week progresses, more days are added to the chain and more, unrelated shifts (e.g., unrelated may include shifts that are not from the same employer and/or part of the same job order as the previous shift) are stitched to the associate's schedule so there is consistently running ˜week of shifts for that associate, thereby approximating full-time employment.

In some embodiments, an associate inputs scheduling parameters over a given time horizon (e.g., the next 30 days). In the scheduling parameters, the associate indicates a number of shifts they want to take over that time horizon and the sort of job types, the pay rate range and even things like distance to job site. These preferences are used to limit/filter the positions the model matches against that associate. The stitching algorithm generates a work schedule spanning the selected time horizon at the indicated frequency (provided jobs exist). The preferences approximate behavior similar to “gig” workers.

The outputs of the predictive work rate model are implemented to allocate a set of shifts that persist until a schedule horizon that advances with time. The predictive work rate model thus generates more temporary employment shifts that approximate full-time work. Further, the shifts are allocated to associates whom the model predicts will complete the dispatch successfully. In some embodiments, the schedule horizon extends based on completion of scheduled shifts.

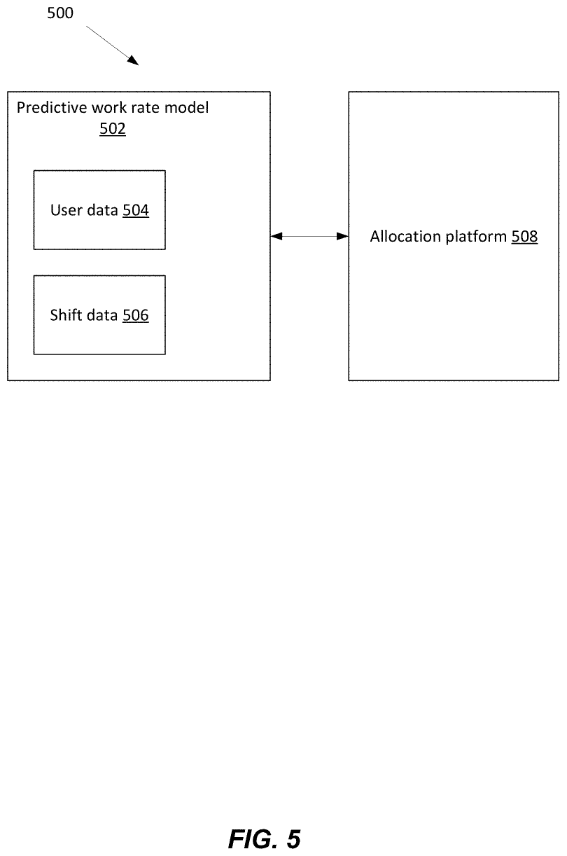

FIG. 5 is a block diagram of a schedule stitching platform. the schedule stitching platform 500 includes the predictive work rate model 502 at the core of a platform that includes user data 504 and shift data 506. The allocation platform 508 may be implemented as another conjoined machine learning model and/or a heuristic model. As a machine learning model, the allocation platform 508 is trained using inputs relating to availability of shifts on the temporary staffing platform at any given time throughout a year as well as simultaneous queries of the predictive work rate model 502.

Where the allocation platform 508 is implemented as a heuristic model, a set of rules and thresholds are established for triggering queries to submit to the predictive work rate model 502. The results of these queries are filtered, and rules allocate each shift to workers. The rules prioritize predicted dispatch success rate over the course of the schedule horizon (e.g., 7 days). The rules applied are different than a human temporary staffing allocator would otherwise apply. Specifically, human allocators base decisions off known relationships to associates, feelings of reliability for associates, and first-come-first-serve metrics.

Conversely, the rules implement machine learning outputs using objective training data and prioritize for a schedule horizon that a human cannot compute.

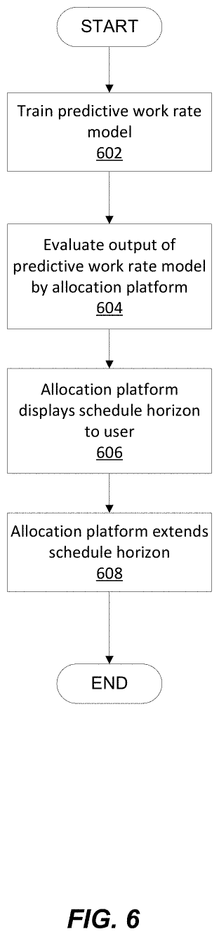

FIG. 6 is a flowchart illustrating an example of schedule stitching using a predictive work rate match. In step 602, the predictive work rate model is trained and receives a set of queries for potential pairings for a given schedule horizon. In step 604, output of the predictive work rate model is evaluated by an allocation platform prioritizing dispatch success over the course of the schedule horizon, where success rate is a first priority followed by associate retention. For example, associate retention is measured in consistent predicted dispatch success for a given associate over the course of the schedule horizon.

In step 606, the allocation platform displays a schedule having the length of the schedule horizon to the associate. The associate is able to accept or decline the schedule. In some embodiments, the associate is enabled to accept partial elements of the schedule, thereby returning the remaining elements to a pool of shifts to allocate. In some examples, a partial acceptance is similar to requesting a day off.

In step 608, as time advances, so does the schedule horizon, and thus the allocated shifts are offered out to the extent of the horizon. For example, where the schedule horizon is seven days, as days pass, additional shifts are offered to the associate to extend their stitched together schedule back out to seven days again. The length of the schedule horizon may be variable. For example, in some cases a shift is available that would last fourteen days. In that case, allocation of this shift extends the horizon from seven to fourteen days.

The schedule horizon may extend in response to the associate completing shifts/tasks and/or in response to the progress of time. In each extension of the stitched schedule, the allocation platform goes back to the predictive work rate model to identify more predicted successful dispatch outcomes to add to the schedule.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps (or employ systems having blocks) in a different order, and some processes or blocks may be deleted, moved, added, subdivided, combined, and/or modified to provide sub- or alternative combinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

All patents, applications, and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the disclosure.

1. A method comprising:
executing, via a processor, an artificial intelligence (AI) machine learning model including a training data set of past pairing outcomes between a task and an associate, each past pairing outcome including a plurality of inputs, the plurality of inputs including a set of associate data and a set of task data, the set of associate data represents a history of pairings for that associate and the set of task data represents parameters of that task;
weighting, by the AI machine learning model, each of the plurality of inputs, the weightings of each of the plurality of inputs based on predictive effectiveness of each of the plurality of inputs;
receiving, by the AI machine learning model, a set of future tasks and a set of associates, each of the set of future tasks and the set of associates having respective task data and associate data;
determining a pairing outcome, by the AI machine learning model, for each combination of each task of the set of future tasks and each associate of the set of associates, wherein a pairing outcome indicates whether a given associate will perform a paired task;
automatically allocating users to tasks based on the determined pairing outcome of each combination; and
modifying the training data set of the AI machine learning model based on actual pairing outcomes of the future tasks.

2. The method of claim 1, wherein the set of associate data includes any combination of:
a) a number of total historical pairings for that associate;
b) a number of paid performed tasks for that associate;
c) the ratio of b) to a);
d) a number of days since that associate's first dispatch;
e) an average number of pairings per day since first pairing for that associate;
f) a set of skills attributed to that associate;
g) an average pay rate for that associate;
h) a most recent pay rate for that associate;
i) a length of that associate's last task;
j) an average length per task performed for that associate;
k) whether that associate's last task was at least eight hours long;
l) a number of tasks performed lasting at least eight hours for that associate;
m) a ratio of tasks lasting at least eight hours to tasks lasting less than eight hours performed by that associate; or
n) a cumulative number of hours worked by that associate.

3. The method of claim 1, wherein the set of task data includes any combination of:
a) identity of a task issuer;
b) an hourly pay rate for that task;
c) a date of performance for that task;
d) a location for that task;
e) a set of skills required for that task;
f) a set of duties for that task;
g) an industry category for that task;
h) a title for the that task; or
i) a length of time for that task.

4. The method of claim 1, wherein said determining a pairing outcome further comprises:
deriving, by the machine learning model from the task data of the set of future tasks and the associate data of the set of associates, a set of additional pairing inputs from which to base the determination of pairing outcome, the set of additional pairing inputs including any combination of:
(a) a total number of dispatches that associate has had for a specific customer associated with that task;
(b) whether that associate's last paid task's pay rate matches that task's pay rate;
(c) a number of paid tasks that associate had for the specific customer;
(d) that associate's ratio of total paid tasks to total dispatches for the specific customer;
(e) whether any of the associate's skills match skills associated with that task;
(f) how far that associate's home is from a task site;
(g) how many times that associate worked a task with the same task title; or
(h) whether that associate's last task was with the specific customer.

5. The method of claim 1, wherein the pairing outcome is a predicted confidence score of dispatch outcome.

6. The method of claim 5, wherein the pairing outcome is represented as a binary value based on whether the predicted confidence score meets a predetermined threshold.

7. A method comprising:
executing, via a processor, an artificial intelligence (AI) machine learning model including a training data set of past pairing outcomes between a task and an associate, each past pairing outcome including a plurality of inputs, the plurality of inputs including a set of associate data and a set of task data;
receiving, by the AI machine learning model, a future task and a first associate, each having respective task data and associate data;
determining a pairing outcome, by the AI machine learning model, for the future task and the first associate, wherein a pairing outcome indicates a prediction whether the first associate will attend and complete the future task when dispatched;
automatically allocating the first associate to the future task in response to the pairing outcome meeting a predetermined threshold of predicting that the first associate will attend and complete the future task when dispatched; and
modifying the training data set of the AI machine learning model based on an actual pairing outcome of the future task.

8. The method of claim 7, wherein the pairing outcome is represented as a binary value based on whether the pairing outcome meets the predetermined threshold.

9. The method of claim 7, wherein the set of associate data includes any combination of:
a) a number of total historical pairings for the first associate;
b) a number of paid performed tasks for the first associate;
c) the ratio of b) to a);
d) a number of days since the first associate's first dispatch;
e) an average number of pairings per day since first pairing for the first associate;
f) a set of skills attributed to the first associate;
g) an average pay rate for the first associate;
h) a most recent pay rate for the first associate;
i) a length of the first associate's last task;
j) an average length per task performed for the first associate;
k) whether the first associate's last task was at least eight hours long;
l) a number of tasks performed lasting at least eight hours for the first associate;
m) a ratio of tasks lasting at least eight hours to tasks lasting less than eight hours performed by the first associate; or
n) a cumulative number of hours worked by the first associate.

10. The method of claim 7, wherein the set of task data includes any combination of:
a) identity of the task issuer;
b) an hourly pay rate for the future task;
c) a date of performance for the future task;
d) a location for the future task;
e) a set of skills required for the future task;
f) a set of duties for the future task;
g) an industry category for the future task;
h) a title for the future task; or
i) a length of time for the future task.

11. The method of claim 7, wherein said determining a pairing outcome further comprises:
deriving, by the machine learning model from the task data of the future task and the associate data of the first associate, a set of additional pairing inputs from which to base the determination of pairing outcome, the set of additional pairing inputs including any combination of:
(a) a total number of dispatches the first associate has had for a specific customer associated with the future task;
(b) whether the first associate's last paid task's pay rate matches the future task's pay rate;
(c) a number of paid tasks the first associate had for the specific customer;
(d) the first associate's ratio of total paid tasks to total dispatches for the specific customer;
(e) whether any of the first associate's skills match skills associated with the future task;
(f) how far the first associate's home is from the task site;
(g) how many times the first associate worked a task with the same task title; or
(h) whether the first associate's last task was with the specific customer.

13. The method of claim 7, further comprising:
receiving, by the AI machine learning model, a set of additional future tasks, each having respective task data;
determining the pairing outcome, by the AI machine learning model, for each of set of additional future tasks and the first associate;
generating, by the AI machine learning model, a schedule for the first associate from amongst the future task and the set of additional future tasks that extends to a schedule horizon, where tasks included in the schedule are based on pairing outcomes of each task paired with the first associate.

14. The method of claim 13, further comprising:
In response to the first associate completing the first task, adding additional tasks to the schedule based on pairing outcomes thereof that extend the schedule horizon.

15. A system for comprising:
a processor;
a memory;
an artificial intelligence (AI) machine learning model stored in the memory and executed by the processor and trained via training data set, the machine learning model configured to:
receive a set of future tasks and a set of associates each having respective task data and associate data;
based on a weighting of a plurality of inputs, determine a pairing outcome for each combination of each task of the set of future tasks and each associate of the set of associates, wherein a pairing outcome indicates whether a given associate will perform a paired task; and
automatically allocate associates to future tasks based on the determined pairing outcome of each combination.

16. The system of claim 15, wherein the AI machine learning model has been trained on a training data set of past pairing outcomes between a task and an associate, each past pairing outcome including a plurality of inputs, the plurality of inputs including a set of associate data and a set of task data, wherein the set of associate data represents a history of pairings for that associate and the set of task data represents parameters of that task.

17. The system of claim 16, wherein the set of associate data includes any combination of:
a) a number of total historical pairings for that associate;
b) a number of paid performed tasks for that associate;
c) the ratio of b) to a);
d) a number of days since that associate's first dispatch;
e) an average number of pairings per day since first pairing for that associate;
f) a set of skills attributed to that associate;
g) an average pay rate for that associate;
h) a most recent pay rate for that associate;
i) a length of that associate's last task;
j) an average length per task performed for that associate;
k) whether that associate's last task was at least eight hours long;
l) a number of tasks performed lasting at least eight hours for that associate;
m) a ratio of tasks lasting at least eight hours to tasks lasting less than eight hours performed by that associate; or
n) a cumulative number of hours worked by that associate.

18. The system of claim 16, wherein the set of task data includes any combination of:
a) identity of a task issuer;
b) an hourly pay rate for that task;
c) a date of performance for that task;
d) a location for that task;
e) a set of skills required for that task;
f) a set of duties for that task;
g) an industry category for that task;
h) a title for the that task; or
i) a length of time for that task.

19. The system of claim 16, wherein to determine the pairing outcome further comprises:
deriving, by the machine learning model from the task data of the set of future tasks and the associate data of the set of associates, a set of additional pairing inputs from which to base the determination of pairing outcome, the set of additional pairing inputs including any combination of:
(a) a total number of dispatches that associate has had for a specific customer associated with that task;
(b) whether that associate's last paid task's pay rate matches that task's pay rate;
(c) a number of paid tasks that associate had for the specific customer;
(d) that associate's ratio of total paid tasks to total dispatches for the specific customer;
(e) whether any of the associate's skills match skills associated with that task;
(f) how far that associate's home is from a task site;
(g) how many times that associate worked a task with the same task title; or
(h) whether that associate's last task was with the specific customer.

20. The system of claim 16, wherein the pairing outcome is a predicted confidence score of dispatch outcome.
